(19) United States
(12) Patent Application Publication
(10) Pub. No.: US 2014/0027378 A1
(43) Pub. Date: Jan. 30, 2014

(54) BIOFILM CARRIER SCREEN

(71) Applicant: Anaergia Inc., Burlington (CA)

(72) Inventors: Juan Carlos JOSSE, Mission Viejo, CA (US); Sasha ROLLINGS-SCATTERGOOD, Fergus (CA); Michael THEODOULOU, Milton (CA)

(73) Assignee: ANAERGIA INC., Burlington (CA)

(21) Appl. No.: 13/941,997

(22) Filed: Jul. 15, 2013

Related U.S. Application Data
(60) Provisional application No. 61/676,131, filed on Jul. 26, 2012.

(51) Int. Cl. C02F 3/00

(52) U.S. Cl. CPC C02F 3/00
USPC 210/615; 210/150

(57) ABSTRACT

A biofilm carrier screen is adapted for use with a moving bed bioreactor (MBBR). The screen has a screening body connected to an effluent pipe. The effluent pipe optionally has two parts separated by a union, preferably a pitless adapter. The screening body can be lifted from a bioreactor tank for maintenance after disconnecting the union. The screening body may have an aerator to provide bubbles to disperse biofilm carriers from the screening body. The screening bod may extend downwards from a mount near the top of the tank. In the case of an anaerobic MBBR, the screening body may extend downwards from a service box through a cover over the tank.

### RELATED APPLICATION

This application claims the benefit under 35 USC 119 of Provisional Application No. 61/676,131 filed on Jul. 26, 2012 which is incorporated herein by reference.

### FIELD

This disclosure relates to water treatment with bioreactors and in particular to moving bed biofilm bioreactors (MBBR).

### BACKGROUND

The following discussion is not an admission that anything discussed below is citable as prior art or common general knowledge.

In biological water treatment, a growth of microorganisms, for example aerobic or anaerobic bacteria, consumes one or more components dissolved or suspended in the water. In general, the microorganism may be in the form of an attached growth, a suspended growth, or both.

In some attached growth systems, a biofilm containing the microorganisms grows on a moving surface. In a moving bed biofilm reactor (MBBR), a large number of biofilm carriers, sometimes called carriers for brevity, in a tank provide supporting surfaces for biofilm. The biofilm carriers are typically made of plastic or another material having a density near the density of water. The size of individual biofilm carriers may be in the range of a few millimeters to a few centimeters. Small biofilm carries may be in the form of spheres or cylinders. Larger carriers may have shapes that provide a large protected inner surface area within an outer shell. When operating, one or more mixing devices such as an aerator or a mixing paddle distribute the biofilm carriers around the tank and keep at least some of them in suspension in the water. In some cases, there is also suspended growth in the MBBR. For example, in the integrated fixed film activated sludge (IFAS) process, return activated sludge (RAS) recirculates through an MBBR.

### INTRODUCTION

In a moving bed biofilm reactor (MBBR), water flows through a tank and contacts biofilm attached to carriers confined to the tank. A screen covers the outlet of the tank to prevent the biofilm carriers from leaving the tank with the treated water. However, the flow of water through the screen tends to collect carriers against the screen. This interferes both with operation of the screen and suspension of the carriers. The screen may also need to be cleaned or repaired at some times but the water around the screen may be murky and contain pathogens. In the case of an anaerobic MBBR, the biofilm also releases biogas. The biogas is both a greenhouse gas and a valuable product and so a cover is placed over the tank to contain the biogas. The cover and the toxicity of the biogas under the cover make it more difficult to access the screen for cleaning or other maintenance.

This specification describes a screen adapted for use with a bioreactor, for example an MBBR. The screen has a screening body connected to at least part of an effluent conduit. The screening body may extend downwards from a supporting structure that is adapted for mounting near the top of a tank. In operation, the screening body extends downwards into water in the tank. Water flows through the screening body to reach an inlet of the effluent conduit open to the inside of the screening body. Screened water then travels through the effluent conduit to leave the tank. The screening body prevents particles of a selected size, for example biofilm carriers, from reaching the inlet of the effluent conduit. In the case of an anaerobic bioreactor, the supporting structure may be part of a service box allowing access to the inside of the tank through a cover.

Preferably, a mount for the screening body allows the screening body to be raised or lowered relative to the tank. If the effluent conduit is rigid, it is preferably in two or more parts separated by a union such as a pitless adapter. One part of the effluent conduit, located on one side of the union, passes through the tank wall. Another part of the effluent conduit, located on the other side of the union, connects to the screening body. In the case of a pitless adapter, raising the screening body automatically disconnects the pitless adapter while lowering the screening body re-connects the pitless adapter. In the case of an anaerobic bioreactor, there may be a hatch in a tank cover or service box over the screening body. In use, the hatch allows the screening body to be lifted clear of water in the tank.

Screened particles may be discouraged from collecting against the outside of the screening body by placing the screening body near or over an agitator, for example an aerator or paddle, in the tank. Preferably, the screen has an agitator connected to the screening body. For example, the screening body may have an aerator connected to the outside of the screening body near the bottom of the screening body. The aerator produces a curtain of bubbles that rise along, or parallel to, the outer surface of the screening body. Preferably, the aerator can be lifted clear of water in the tank by raising the screening body. In the case of an anaerobic MBBR, the bubbles may be produced by recirculating biogas from within a cover of the tank to the aerator.

This specification also describes a moving bed biofilm reactor and water treatment method. The reactor has a tank and a screening body attached to an effluent conduit through a pitless adapter. In the case of an anaerobic MBBR, the screening body may extend downwards from a service box that passes through a cover of the tank. In the method of treating water, water flows into the tank and contacts biofilm carriers in the tank. Microorganisms, for example anaerobic methanogens, grow on the carriers. Treated water flows through the screening body to the inlet of an effluent conduit open to the inside of the screening body. Optionally, bubbles produced outside of the screening body help disperse biofilm carriers from the screening body. In another option, water flowing into the tank may contain a suspended growth of microorganisms, for example anaerobic methanogens.

### BRIEF DESCRIPTION OF THE DRAWINGS

FIG. 1 is a schematic cross-sectioned side view of a bioreactor with a biofilm carrier screen.

FIG. 2 is an enlarged view of a portion of FIG. 1.

### DETAILED DESCRIPTION

The detailed description to follow describes a biofilm carrier screen for use with a moving bed bioreactor (MBBR) used to treat wastewater. The reactor has carriers contained in a tank by the screen. The screen may be removed from the water for maintenance or replacement without emptying the water from the tank. This reduces disturbance to reactions in the reactor, which may take weeks or more to be established. In the case of an anaerobic MBBR, the screen may also be removed from the water without having to vent the headspace of the tank. This avoids contaminating the reactor or a biogas product with air. The configuration of the screen also provides a large screening area. Optionally, an attached agitator helps keep carriers away from the screen in use. By being attached, the agitator can act directly on the screen and be removed with the screen for maintenance. In another option, a pitless adapter may be used to avoid having to separately disconnect a union in an effluent conduit (which may be immersed in sludge) when removing the screen. In the example shown in the Figures, all of these features are combined in an anaerobic MBBR. However, in other embodiments, any subset of these features may be used for their individual advantages.

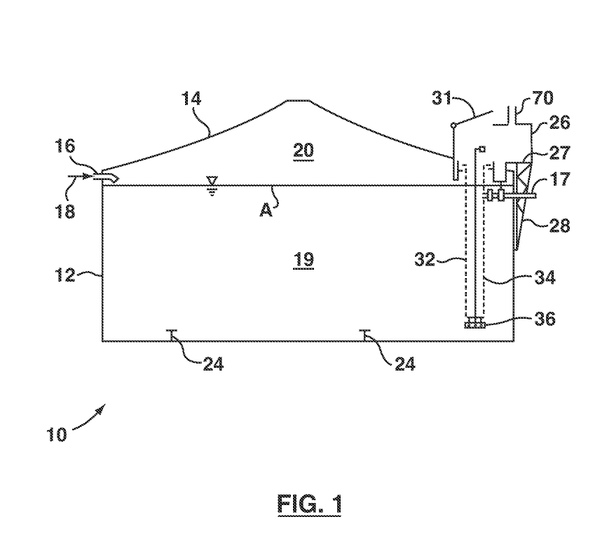

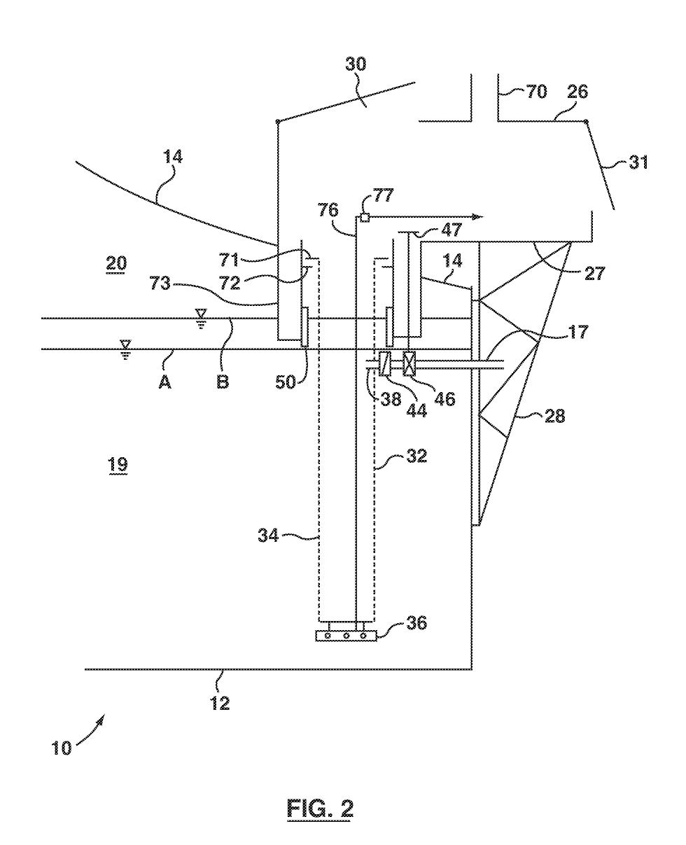

FIGS. 1 and 2 show a bioreactor 10, in particular an MBBR. The bioreactor 10 may operate under aerobic or anaerobic conditions. In use as an MBBR, the bioreactor 10 contains biofilm carriers. The carriers are not shown in the Figures since the individual carriers are typically too small to be shown in detail. Any custom made or commercially available type of carrier may be used.

The bioreactor 10 comprises a tank 12, a cover 14 and a service box 26. The cover 14 is typically omitted for an aerobic MBBR. The tank 12 can be any structure that will contain the contents of the bioreactor 10. The cover 14 engages the top of the tank 12 in a generally airtight manner to capture biogas produced in the bioreactor 10. The service box 26 may be generally similar to service boxes sold by UTS Biogas but with modifications according to the description below.

The bioreactor 10 also includes an inlet pipe 16 and an effluent conduit 17. The inlet pipe 16 introduces wastewater 18 to the bioreactor 10 for treatment. The wastewater 18 may be industrial wastewater, municipal wastewater treatment sludge, agricultural or food processing waste, or another feed stream that can be treated by microorganisms, for example methanogens, attached to biofilm carriers within the bioreactor 10. In some cases, the feed stream may be a high solids suspension or slurry and other feeding mechanisms may be used. The microorganisms break down one or more components of the wastewater 18 to produce sludge 19 in the tank 12. For example, the sludge 19 may have reduced biochemical oxygen demand.

The microorganisms may also produce a biogas product. The biogas is typically a mixture of methane, carbon dioxide, and other gasses. The biogas is initially contained within a headspace 20 between the surface of the sludge 19 and the cover 14. The biogas is extracted from the headspace 20 for use, for example, to produce heat or electricity. The biogas is preferably removed from the headspace 20 through a biogas collection pipe 70 passing through a wall of the service box 26. Alternatively, the biogas collection pipe 70 can extend the through a section of the cover 14 or an upper section of the tank 12.

Biofilm carriers, not shown, are suspended within the sludge 19 to support the microorganisms. The carriers are typically inert and do not contribute to the reactions that occur within the bioreactor 10. The carriers typically have a high surface area per unit volume to support a large area of biofilm while being easily moved throughout the tank 12 to contact the sludge 19. The carriers may be of any commercially available carrier type.

The bioreactor 10 can include one or more mixers 24, alternatively called agitators, to distribute and move the biofilm carriers throughout the tank 12. A generally even distribution of the carriers assists the reactions between the microorganisms and the sludge 19. A mixer 24 may be a mechanical mixer with paddles, blades or other suitable features. Alternatively, a mixer 24 may be an aerator, sparger or diffuser that releases gas bubbles into the sludge 19. The gas used to make the bubbles may be biogas drawn from the headspace 20.

The bioreactor 10 also includes the service box 26. The service box 26 may be supported on a wall or the floor of the tank 12 by a frame 28. The frame 28 can be located inside or outside of the tank 12. Optionally, the frame 28 distances the service box 26 from the inner wall of the tank 12. The service box 26 preferably includes a platform 27 suitable to support a person who is working on the bioreactor 10. At least a portion of the service box 26 extends through the cover 14. A generally gas tight seal is formed between the exterior of the service box 26 and the cover 14 to prevent the escape of biogas. The service box 26 includes a lid 30 that, when opened, allows equipment to be lowered into the tank 12 through the service box 26. Optionally, the service box 26 may also have a hatch 31 to provide a separate way for a person working on the bioreactor 10 to enter the service box 26.

The service box 26 also supports a carrier screen 32. The carrier screen 32 comprises a screening body 34. The screening body 34 is at least partially made up of a mesh, perforated or other material having openings. The openings have a shape and size that contains a selected type of biofilm carrier in the tank 12. The screening body 34 may have an elongated prismatic shape. For example, the screening body 34 may be in the shape of a tube. The bottom of the screening body 34 is covered with a material that may be solid or have openings. The top of the screening body 34 may also be covered but it is preferably left open. In this way, the interior of the screening body 34 can be reached for maintenance, for example to clean the screening body 34 by spraying water through it from the inside out.

The carrier screen 32 may also have an agitator 36 and a collection pipe 38. The collection pipe 38 may be part of the effluent conduit 17 when the carrier screen 32 is in use. The carrier screen 32 may be suspended from the service box 26 when in use by way of a lip 71 of the carrier screen resting on a flange 72 in a curtain 73 of the service box 26. Optionally, the lip 71 may be attached to the flange 72, for example by a bolt, clamp or pin. Opening the lid 30 and releasing the attachment, if any, allows the carrier 32 to be lifted out of the sludge 19 for installation, maintenance or replacement.

While the carrier screen 32 is in use, the screening body 34 extends from the service box 26 into the tank 12 and below the surface level of the sludge 19. The depth that the screening body 34 extends into the sludge 19 may vary. If biogas is removed through a biogas collection pipe 70 in the service box 26, the sludge 19 is kept below the curtain 73 of the service box 26, for example at line A in the Figures. Preferably, the top of the carrier screen 32 is always above the surface of the sludge 19 so that it can be reached without reaching through the sludge 19 and so that carriers do not enter the interior of the screening body 34 even if it has an open top. Sludge 19 passes through the screening body 34 to the interior of the carrier screen 32 while the biofilm carriers are retained in the tank 12.

The agitator 36 may be located near the bottom of the screening body 34. Preferably, the agitator is attached to the screening body 34. Alternatively, the agitator 36 may be supported on a separate frame (not shown) that supports the agitator 36 at or near the bottom of the screening body 34 from the floor or wall of the tank 12. The agitator 36 preferably has holes spaced around the periphery of the bottom of the screening body 34 and provides a curtain of bubbles that rise from the agitator 36 to the surface of the sludge 19. For example, if the cross-sectional shape of the screening body 34 is circular, the agitator 36 may be a ring or torus shaped diffuser. The agitator 36 may be fed biogas from a pump (not shown) with its inlet in communication with the headspace 20 and its outlet in communication with a gas feed line 76. The gas feed line 76 extends from the service box 26 to the agitator 36 inside or outside of the screening body 34. The gas feed line 76 preferably has a union 77 that allows it to be released from the pump when the carrier screen 32 is removed from the sludge 19. In use, bubbles travel very close to, and perhaps along, the sides of the screening body 34 to move carriers away from the screening body 34 and help avoid concentrating carriers near the screening body 34.

Sludge 19 that passes through the screening body 34 flows into the collection pipe 38. The collection pipe 38 has an inlet in communication within the interior of the screening body 34 and an outlet in fluid communication with the remainder of the effluent conduit 17 through a union 44, alternatively called a pipe coupler. The union 44 is preferably a snap-on type coupled that can be disengaged by lifting the carrier screen 32. For example, the pipe coupler 44 may be a pitless adapter of the type used to insert a pump into a well shaft.

To perform maintenance on the carrier screen 32, the sludge 19 is raised to level B or a movable portion 50 of the curtain 73 is lowered into the sludge 19. This prevent biogas from flowing from the headspace 20 to the interior of the service box 26. Alternatively, with a biogas collection pipe 70 that does not pass through the service box 26, the sludge 19 may be already at level B. Biogas in the service box 26, if any, is vented, for example through lid 30, hatch 31 of biogas collection pipe 70. If necessary, an isolation valve 46 in the effluent conduit 17 is closed. In the example shown, a handle 47 to close the isolation valve 46 is reached through the service box 26. Alternatively, the isolation valve 46 may be located outside of the tank 12. Union 77 in the gas feed line 76, if any, is separated. The carrier screen 26 may then be lifted from the sludge 19, passing though the lid 30 if necessary. Lifting the carrier screen 26 automatically separates the union 44 if it is a pitless adapter or snap-on coupler. Otherwise, the union 44 is disconnected through the service box 26 before lifting the carrier screen 26. The flange 72 may have a notch (not shown) to allow the collection pipe 38 and attached part of the coupler 44 to pass through the flange 72. Optionally, the carrier screen 26 can be completely removed from the tank 12 and service box 26. These steps are performed generally in reverse order to re-install the carrier screen 26.

When the bioreactor 10 is in use, wastewater 18 treated flows into the tank 12. Organic matter within the wastewater 18 is broken down by microorganisms supported on the carriers and sludge 19 is produced. Breaking down the organic matter may also produce biogas. Some sludge 19 flows out of the tank 12. The carriers are separated from the effluent sludge 19 by passing it through the carrier screen 32. The treatment of the wastewater 18 optionally includes a step of producing bubbles near the screening body 34 to disperse carriers from it. When necessary, the carrier screen 32 can be removed from the sludge 19 as described above for maintenance.

This written description uses examples to disclose the invention and also to enable any person skilled in the art to practice the invention. The scope of the invention is defined by the claims, and may include other examples that occur to those skilled in the art.

We claim:

1. A biofilm carrier screen comprising:
a) a screening body;
b) an effluent pipe having an inlet open to the inside of the screening body; and,
c) at least one side of a pipe union connected to the effluent pipe.

2. The biofilm carrier screen of claim 1 further comprising an aerator connected to the screening body.

3. The biofilm carrier screen of claim 1 further comprising a valve in the effluent pipe, wherein the valve is on the opposite side of the pipe union from the screening body.

4. The biofilm carrier screen of claim 1 wherein the screening body has an elongated prismatic shape and is oriented perpendicular to the effluent pipe.

5. The biofilm carrier screen of claim 1 wherein the screening body has an open top.

6. The biofilm carrier screen of claim 1 wherein the union is a pitless adapter.

7. The biofilm carrier screen of claim 1 further comprising a mount adapted to attach the screening body to a tank.

8. A moving bed biofilm reactor comprising,
a) a tank;
b) a service platform mounted to a wall of the tank;
c) a screening body extending downwards from the service platform; and,
d) an effluent pipe in communication between the inside of the screening body and the outside of the tank.

9. The moving bed biofilm reactor of claim 8 further comprising an agitator connected to the screening body.

10. The moving bed biofilm reactor of claim 8 further comprising a cover over the tank and a service box connected to the service platform wherein the service box passes through the cover.

11. The moving bed biofilm reactor of claim 10 wherein the service box comprises a curtain extending from the service box to below the top of the tank or a curtain that may be selectively extended downwards from the service box.

12. The moving bed biofilm reactor of claim 10 wherein the service box comprises a hatch above the screening body.

13. The moving bed biofilm reactor of claims 8 wherein the effluent pipe comprises a union.

14. The moving bed biofilm reactor of claim 13 wherein the union is a pitless adapter.

15. The moving bed biofilm reactor of claim 8 further comprising a valve in the effluent pipe.

16. The anaerobic moving bed biofilm reactor of claim 8 wherein the top of the screening body is open at or above the service platform.

17. A method of treating water comprising the steps of,
a) providing a tank with a cover;
b) providing a plurality of biofilm carriers in the tank;
c) providing a service box passing through the cover of the tank;
d) providing a screening body extending downwards from the service box into the tank, the screening body having openings adapted to retain the biofilm carriers in the tank;
e) providing an effluent pipe in communication between the inside of the screening body and the outside of the tank;
f) flowing water to be treated into the tank, through the screening body and out through the effluent pipe; and,
g) at some times, forming a seal between the service box and water in the tank.

18. The method of claim 17 wherein step g) comprises raising the level of the water in the tank to the bottom of the service box or lowering a curtain from the service box into water in the tank.

19. The method of any claim 17 comprising a step of withdrawing biogas from the tank through the service box.

20. The method of claim 17 comprising a step of recirculating biogas from a headspace of the tank to an aerator near the screening body.
